(19) United States
(12) Patent Application Publication
(10) Pub. No.: US 2026/0138574 A1
(43) Pub. Date: May 21, 2026

(54) BRAKING SYSTEM FOR A MOTOR VEHICLE AND MOTOR VEHICLE WITH A BRAKING SYSTEM

(71) Applicant: AUDI AG, lngolstadt (DE)

(72) Inventor: Krister PETERSEN, lngolstadt (DE)

(73) Assignee: AUDI AG, lngolstadt (DE)

(21) Appl. No.: 19/337,033

(22) Filed: Sep. 23, 2025

(30) Foreign Application Priority Data
Nov. 19, 2024 (DE) 102024133898.9

(51) Int. Cl. B60T 8/171; B60T 8/172; B60T 8/26; B60T 8/32; B60T 13/74

(52) U.S. Cl. CPC B60T 8/171; B60T 8/172; B60T 8/26; B60T 8/321; B60T 13/745; B60T 2220/04; B60T 2240/00; B60T 2270/10; B60T 2270/30; B60T 2270/402; B60T 2270/88

(57) ABSTRACT

A braking system for a motor vehicle with two control devices, namely a primary control device and a secondary control device. The braking system is configured in such a way that, in a wake-up mode of the braking system, when a driver inputs a braking command, either the primary control device or the secondary control device controls the generation of a braking force in dependence on the input braking command, depending on the situation, namely depending on whether a critical or a non-critical braking situation exists.

### FIELD

The invention relates to a braking system for a motor vehicle. The invention also relates to a motor vehicle with a corresponding braking system.

### BACKGROUND

Most of the passenger cars currently available have a service brake in which each wheel is associated with a hydraulically controlled wheel brake. In such service brakes, a brake pressure is predetermined for the wheel brakes via a hydraulic system of the service brake during a braking operation, which brake pressure is then converted in the respective wheel brake into a wheel braking force dependent on the brake pressure.

In some cases, such a service brake is designed as a so-called electro-hydraulic brake. In an electro-hydraulic brake, the brake pressure is controlled electrically, typically using electrically controlled valves and electric hydraulic pumps in the hydraulic system. The control is carried out depending on sensor signals from a sensor that detects braking commands from a driver, which he or she gives by pressing a brake pedal.

In the event that the electrical control in an electro-hydraulic brake fails, a so-called mechanical-hydraulic fallback level is typically implemented in electro-hydraulic brakes. For this purpose, the brake pedal is coupled to the hydraulic system so that hydraulic pressure can be exerted by operating the brake pedal and converted into brake pressure via the hydraulic system. In the mechanical-hydraulic fallback level, the brake pressure is then controlled without electrical signals, as the actuation of the brake pedal is converted into brake pressure via a purely mechanical-hydraulic coupling.

So-called electro-mechanical brakes are also known. Such an electro-mechanical brake is described, for example, in US 2012/0 118 681 A1.

### SUMMARY

The object of the present invention is to provide an advantageously designed braking system for a motor vehicle and an advantageously designed motor vehicle with a corresponding braking system.

This object is achieved by a braking system and by a motor vehicle. The advantages and preferred embodiments mentioned with regard to the braking system can also be transferred to the motor vehicle and vice versa.

The braking system according to the invention is designed and constructed for a motor vehicle. Therefore, the braking system, when installed or fitted, is expediently part of a motor vehicle.

The motor vehicle according to the invention comprises a braking system according to the invention. It is designed in particular as a passenger car.

The braking system, i.e. the braking system according to the invention, is designed and constructed in particular for a passenger car. In addition, it expediently has one and preferably only one service brake, which is designed in particular in the manner of a so-called brake-by-wire brake.

Furthermore, the braking system and in particular the service brake has an input device with an operating element via which braking commands can be input by a driver, namely by manually operating the operating element. In addition, the input device expediently has at least one operating element sensor associated with the operating element for the sensory detection of input braking commands.

The operating element is typically designed as a so-called brake pedal, which is usually arranged in the footwell of a motor vehicle and can be operated with a foot when the braking system is installed. Alternatively, the operating element is designed for manual operation and, when the braking system is installed, is positioned on or in the region of a steering wheel, for example.

Part of the braking system and in particular of the service brake is also an electrically controllable braking device for generating braking torques or braking forces as well as a control device for controlling the braking device, namely expediently by means of electrical signals, i.e. electrical control signals. The control is carried out in particular depending on input and sensor-detected braking commands. This means that the control device is expediently configured to further process sensor-detected braking commands and, based thereon, to generate electrical control signals for controlling the braking device. The electrically controllable braking device is typically part of the aforementioned service brake of the braking system. Furthermore, the control device has two control devices, namely a primary control device and a secondary control device.

In addition, the braking system and in particular the service brake has a sensor device for generating sensor signals by means of which a braking situation can be determined. This means that the sensor device can be used to conveniently represent the situation in which a driver inputs a braking command.

The braking system and in particular the service brake of the braking system is further configured for at least three operating modes, namely a sleep mode, a wake-up mode and an awake mode. The awake mode is conveniently designed for driving operation. This means that the awake mode is active or activated in the installed state of the braking system in particular when the motor vehicle in which the braking system is installed is activated, i.e. when the motor vehicle has been started and is therefore ready to be driven. Sleep mode, on the other hand, is conveniently designed for longer periods of non-use of the braking system or at least the service brake of the braking system. This means that the sleep mode in the installed state of the braking system is active or activated in particular when the motor vehicle is deactivated, i.e. when the motor vehicle has been parked. The wake-up mode, in turn, is expediently active or activated in an interim period between operation of the braking system in sleep mode and operation of the braking system in wake mode. The wake-up mode is therefore in particular a transitional operating mode.

Furthermore, the sleep mode is usually designed in such a way that neither of the two control devices is active or activated in the sleep mode, i.e. neither the primary nor the secondary. In sleep mode, no evaluations are carried out, no calculations are made and/or no electrical control signals are generated. The two control devices are essentially asleep.

In awake mode, however, both control devices, the primary and the secondary, are usefully active or activated, so they are essentially awake. Therefore, braking commands typically input in the awake mode are detected by sensors and the braking commands detected by sensors are then preferably further processed by both control devices, wherein electrical control signals for controlling the electrically controllable braking device are generated in particular as a function of the braking commands detected by sensors.

Also, since in the case of typical embodiment variants for the sleep mode and the wake mode, a change from the sleep mode to the wake mode cannot usually occur abruptly, the braking system, as already explained, is also configured for the wake-up mode and thus in particular for a transition from the sleep mode to the awake mode with an intermediate operation in the wake-up mode, in which both control devices virtually wake up.

In this wake-up mode, both control devices preferably execute a respective start-up procedure, wherein a diagnostic procedure is typically part of a corresponding start-up procedure. The braking system and in particular the service brake is further preferably configured such that in the wake-up mode the primary control device executes a primary start procedure and the secondary control device executes a secondary start procedure, wherein the secondary start procedure is completed in a shorter time than the primary start procedure.

Apart from that, the braking system is configured in such a way that in the wake-up mode, sensor signals are generated by means of the aforementioned sensor device and that these sensor signals are evaluated by the previously described control device, wherein, based on these sensor signals, it is determined whether a critical or a non-critical braking situation exists. If a braking command is then input in wake-up mode, the primary control device of the control device controls the braking device to generate a braking force depending on the input braking command if a non-critical braking situation exists, and otherwise, i.e. if a critical braking situation exists, the secondary control device of the control device controls the braking device to generate a braking force depending on the input braking command.

This situation-dependent, i.e. braking situation-dependent, task allocation to the primary control device or the secondary control device preferably only occurs in wake-up mode and in no other operating mode.

A non-critical braking situation is conveniently defined as a situation in which a motor vehicle equipped with the braking system is stationary and is not in danger of rolling or slipping away. In this case, a critical situation is appropriately defined as a situation in which the motor vehicle in question is in danger of rolling or slipping away, or a situation in which the motor vehicle in question is already rolling or slipping away.

Furthermore, the braking system is preferably configured such that, at least in the installed state of the braking system, a change from sleep mode to wake-up mode occurs when the motor vehicle in which the braking system is installed is started or when the aforementioned operating element is actuated during sleep mode. To detect such an actuation, the braking system typically has a simple sensor that is assigned to the operating element. This simple sensor is further preferably used only to detect whether the operating element is operated or not. It is therefore typically not possible to detect the input of a braking command.

Furthermore, the aforementioned simple sensor is preferably part of a simple wake-up circuit, by means of which the detection of an actuation of the operating element in sleep mode is possible. The braking system is then configured in such a way that the wake-up circuit puts the braking system into wake-up mode when a corresponding actuation is detected or acknowledged. This means that when the wake-up circuit detects that the operating element is actuated in sleep mode, it wakes up the primary control device and/or the secondary control device.

The detection of an input of a braking command is preferably carried out by means of at least one operating element sensor, with which in particular a position or setting of the operating element can be detected, for example the position of the aforementioned brake pedal. Further preferably, this at least one operating element sensor is not active or not activated in sleep mode and therefore does not detect any inputs in sleep mode. In wake-up mode, however, the at least one operating element sensor is expediently active or activated and thus detects input braking commands.

Further preferred embodiments are those in which the aforementioned sensor device has a number of wheel speed sensors for generating the sensor signals and in which it is determined based on the sensor signals of the wheel speed sensors whether a critical or a non-critical braking situation exists. In some applications, the wheel speed sensors also form the sensor device and the determination of whether a critical or non-critical braking situation exists in these cases is then carried out solely on the basis of the sensor signals from the wheel speed sensors. Further sensor signals from other sensors are then not taken into account. In other applications, the sensor device comprises a number of acceleration sensors as an alternative or in addition to the number of wheel speed sensors, and in these cases, it is then determined alternatively or additionally based on the sensor signals of the acceleration sensors whether a critical or a non-critical braking situation exists.

It is also expedient if the aforementioned service brake of the braking system is designed as a so-called electro-hydraulic brake and if this is the only service brake of the braking system. Typically, the braking system also has a parking brake, for example a purely mechanical parking brake, and in some applications also a regeneration brake, also called a regenerative brake.

If the service brake of the braking system is designed as such an electro-hydraulic brake, the braking system and in particular the electrically controllable braking device typically has a number of wheel brakes and an electrically controllable hydraulic system. The braking system is then further designed in such a way that a hydraulic pressure can be predetermined in each wheel brake by means of the hydraulic system in order to generate a wheel braking force. All wheel braking forces together then result in a braking force, i.e. a total braking force that is generated by the braking system.

Further preferably, the hydraulic system has an electrically controllable pressure control device. Typically, this pressure control device is formed by a number of electrically controllable units, namely in particular by valves and hydraulic pumps. In this case, the pressure control device usually also has a primary part and a secondary part, wherein the primary part is connected to the primary control device in terms of signal technology and wherein the secondary part is connected to the secondary control device in terms of signal technology.

Furthermore, the braking system is then preferably configured such that, on the one hand, wheel braking forces can be predetermined by means of the primary control device and by means of the primary part of the pressure control device, and, on the other hand, wheel braking forces can be predetermined by means of the secondary control device and by means of the secondary part of the pressure control device. In this way, a kind of redundancy is also created in the braking system, among other things.

The primary control device and the primary part of the pressure control device are further preferably components of a primary brake subsystem. Analogously, the secondary control device and the secondary part of the pressure control device are preferably components of a secondary braking subsystem of the braking system. With the two brake subsystems, i.e. the primary and the secondary brake subsystem, redundancy is then also created in the braking system, wherein on the one hand the brake pressures in the brake cylinders can be predetermined by means of the primary control device and the primary part of the pressure control device, and on the other hand the brake pressures in the brake cylinders can be predetermined by means of the secondary control device and the secondary part of the pressure control device.

It is also advantageous if the two braking subsystems described above are designed differently. The primary braking subsystem is then preferably designed for more comfortable braking force generation and/or braking force control than the secondary braking subsystem. Also preferably, the secondary braking subsystem is designed to wake up faster than the primary braking subsystem. This means that after a change from sleep mode to wake-up mode, the secondary braking subsystem is preferably ready to apply wheel braking forces in dependence on an input braking command more quickly than the primary braking subsystem. For this purpose, the primary braking subsystem is preferably designed in such a way that it allows more comfortable and, in particular, more acoustically pleasant wheel braking forces to be predetermined as a function of an input braking command than with the secondary braking subsystem.

If the two braking subsystems are designed in the manner described above, it follows that in wake-up mode, when a braking command is input, the more quickly available secondary braking subsystem is used to generate a braking force if the braking situation is critical, and that the later available but more comfortable primary braking subsystem is used to generate a braking force if the braking situation is not critical.

Reference should also be made again to the previous explanations, according to which both control devices preferably execute a start procedure in wake-up mode, i.e. typically the primary control device executes the primary start procedure and the secondary control device executes the secondary start procedure. In this case, the respective brake subsystems are then expediently put into their operational state by means of or through the corresponding start procedures and, in particular, the corresponding parts of the pressure control device are also put into their operational state.

Furthermore, the two parts of the pressure control device, i.e. the primary and the secondary part, are usually designed differently, which typically affects the duration in which the operational state can be reached and thus also the duration of the respective start-up procedure. This means that in some embodiment variants, the secondary start procedure is carried out in a shorter time than the primary start procedure at least also because the secondary part of the pressure control device can be put into the operational state in a shorter time than the primary part of the pressure control device. For example, the primary part of the pressure control device has a number of linear actuators, whereas the secondary part of the pressure control device does not have any linear actuators.

Independently of this, the two control devices are preferably connected to each other for signal and/or data exchange, for example via a field bus or data bus. By means of the connection and a corresponding signal and/or data exchange during operation, it is further preferably ensured that in the event of an error or defect in the primary control device, the secondary control device virtually takes over the tasks of the primary control device.

In most applications, the braking system, and in particular the service brake, does not have a mechanical-hydraulic fallback level, a mechanical-pneumatic fallback level and/or a purely mechanical fallback level.

It is also advantageous if the braking system and in particular the service brake is configured in such a way that when a braking command is input in the awake mode of the braking system, i.e. in an operating mode for driving, the primary control device controls the hydraulic system in such a way that a base pressure is hydraulically predetermined in each wheel brake as a function of the braking command, and that the secondary control device controls the hydraulic system, if necessary, in such a way that the base pressure is varied individually in each wheel brake in order to implement, for example, an ABS function (ABS: anti-lock braking system) and/or an ESP function (ESP: electronic stability program), i.e. driving dynamics control.

Typically, the braking system, and in particular the service brake, is also configured in such a way that the supply of electrical energy to the primary control device is deactivated in sleep mode. In an advantageous further development of the braking system and in particular of the service brake, after a change to the wake-up mode, the supply to the primary control device is reactivated by the secondary control device.

### BRIEF DESCRIPTION OF THE FIGURES

Further advantages, features, and details of the invention result from the claims, the following description of preferred exemplary embodiments and on the basis of the schematic drawings. In particular:

FIG. 1 shows, in a simplified side view, a motor vehicle with a braking system; and

FIG. 2 shows a simplified block diagram of the motor vehicle with the braking system.

### DETAILED DESCRIPTION

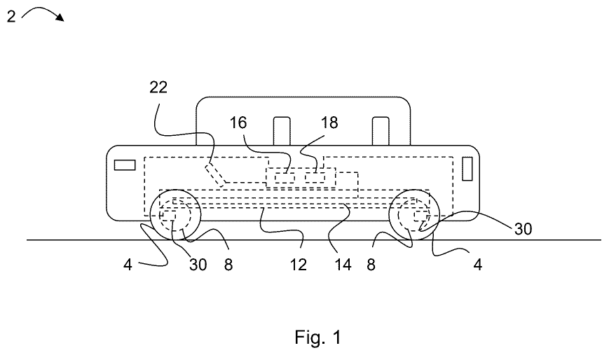

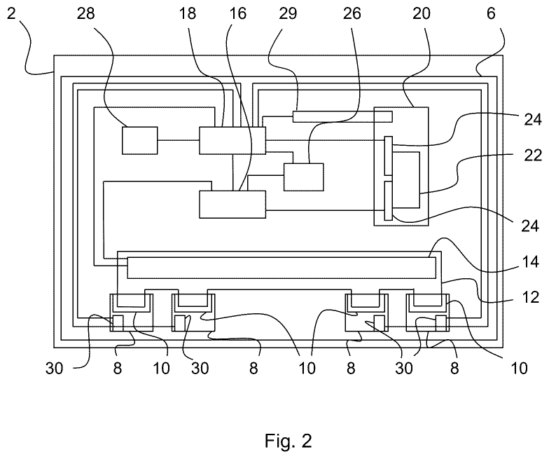

A motor vehicle 2 described below as an example is shown schematically in FIG. 1 in a side view and in FIG. 2 in a block diagram. It is designed as a passenger car with four wheels 4 and has a braking system 6 by means of which a braking force can be generated, for example in order to brake the motor vehicle 2 or to hold it in its position. The braking system 6 has a service brake, described in more detail below, which is designed as a so-called electro-hydraulic brake. In addition, the braking system 6 also has a parking brake, not shown.

In the exemplary embodiment, the braking system 6 and in particular the service brake now has four wheel brakes 8, with each wheel 4 of the motor vehicle 2 being assigned a wheel brake 8. Part of each wheel brake 8 is a brake cylinder 10 in which a brake pressure can be hydraulically predetermined. If such a brake pressure is then predetermined, it is converted into a wheel braking force in the corresponding wheel brake 8 according to a known principle. All wheel braking forces together then result in a braking force, i.e. a total braking force.

Part of the braking system 6 and in particular of the service brake is also an electrically controllable hydraulic system 12 which is hydraulically connected to the brake cylinders 10, so that braking pressures in the brake cylinders 10 can be predetermined via the hydraulic system 12. Here, the hydraulic system 12, i.e. the electrically controllable hydraulic system 12, has a number of electrically controllable units, in particular valves and hydraulic pumps, not explicitly shown, which form an electrically controllable pressure control device 14 of the hydraulic system 12 and by means of which the brake pressures in the brake cylinders 10 can be predetermined.

The pressure control device 14, i.e. the electrically controllable pressure control device 14, further comprises two parts in the exemplary embodiment which are not explicitly shown, namely a primary part and a secondary part. The units, i.e. the electrically controllable units, of the primary part are signal-connected to a primary control device 16 and the units of the secondary part are signal-connected to a secondary control device 18.

The primary control device 16 and the primary part of the pressure control device 14 are further components of a primary brake subsystem. Analogously, the secondary control device 18 and the secondary part of the pressure control device 14 are components of a secondary brake subsystem of the braking system 6. With the two brake subsystems, i.e. the primary and the secondary brake subsystem, redundancy is then created in the braking system and in particular in the service brake, among other things, wherein on the one hand the brake pressures in the brake cylinders 10 can be predetermined by means of the primary control device 16 and by means of the primary part of the pressure control device 14 and on the other hand the brake pressures in the brake cylinders 10 can be predetermined by means of the secondary control device 18 and by means of the secondary part of the pressure control device 14.

Furthermore, the braking system 6 has an input device 20 by means of which braking commands from a driver (not shown) can be detected. In the exemplary embodiment, that input device 20 in turn has a brake pedal 22 as an operating element and two brake pedal sensors 24 assigned to the brake pedal 22 as operating element sensors. The two brake pedal sensors 24 are designed for redundant detection of braking commands and both are designed, for example, as position sensors with which the position or arrangement of the brake pedal 22 can be detected. One of the brake pedal sensors 24 is signal-connected to the primary control device 16 and the other to the secondary control device 18.

The braking system 6 designed in this way, and in particular the service brake, is now configured such that when a driver inputs a braking command in an awake mode of the braking system, i.e. when the brake pedal 22 is actuated, the two brake pedal sensors 24 each independently generate an electrical sensor signal which represents the driver's braking command. Subsequently, the primary control device 16 then controls the primary part of the pressure control device 14 in such a way that, depending on the braking command, a base pressure is hydraulically predetermined in each wheel brake 8 and thereby ultimately a braking force.

In this awake mode of the braking system, the secondary control device 18, on the other hand, preferably controls the secondary part of the pressure control device 14 and thus the hydraulic system 12 only when necessary, in such a way that the base pressure is varied individually in each wheel brake 8 when necessary, namely in particular in order to implement an ABS function (ABS: anti-lock braking system) and/or an ESP function (ESP: electronic stability program), i.e. a driving dynamics control.

For the purpose of redundancy, a separate supply of electrical energy is preferably implemented for each of the two control devices 16, 18. For this purpose, the braking system 6 has, for example, at least one separate converter circuit for each of the two control devices 16, 18, i.e. a primary converter circuit 26 for the primary control device 16 and a secondary converter circuit 28 for the secondary control device 18. In an advantageous further development, the two converter circuits 26, 28 are also connected to different accumulators (not shown).

Preferably, the braking system 6 also does not have any mechanical-hydraulic or purely mechanical fallback level. Instead, the braking system is protected against a complete failure by the design described above and the redundancy it provides.

The previously described operating mode of the braking system 6, namely the awake mode, is further designed as an operating mode for driving operation. The braking system 6 and in particular the motor vehicle 2 are configured in such a way that this awake mode is deactivated when the motor vehicle 2 is switched off, i.e. in particular when it is parked. In this state of the motor vehicle 2, another operating mode is activated, namely a sleep mode.

In the exemplary embodiment, the braking system 6 and in particular the motor vehicle 2 are configured such that, among other things, the supply of electrical energy to the hydraulic system 12 is deactivated in this sleep mode. The braking system 6 is thus virtually shut down. Preferably, the supply of electrical energy to the primary control device 16 by the primary converter circuit 26 is also deactivated.

Furthermore, the motor vehicle 2 and in particular the braking system 6 are configured such that when the brake pedal 22 is actuated in the sleep mode of the braking system 6, a simple wake-up circuit 29 detects the actuation and then puts the braking system 6 into a wake-up mode, which serves as a transitional operating mode for a transition from the sleep mode to the wake mode.

In the wake-up mode, the two brake pedal sensors 24 are then activated, among other things, so that in the event of a brake command being input by a driver, i.e. when the brake pedal 22 is actuated, electrical sensor signals are generated by the two brake pedal sensors 24 and transmitted to the control devices 16, 18. In addition, the hydraulic system 12 is reactivated.

Furthermore, in the wake-up mode, the secondary control device 18 executes a start-up procedure, namely a secondary start-up procedure, and thereby puts the secondary part of the pressure control device 14 into an operational state.

If, as preferred, the supply of electrical energy to the primary control device 16 is deactivated in sleep mode, the supply of electrical energy to the primary control device 16 is also reactivated in wake-up mode by the secondary control device 18. Alternatively, the supply of electrical energy to the primary control device 16 is reactivated by the wake-up circuit 29. Furthermore, in the wake-up mode, the primary control device 16 executes a start-up procedure, namely a secondary start-up procedure, and thereby puts the primary part of the pressure control device 14 into an operational ready state.

Once both start procedures have been executed and both parts of the pressure control device 14 are in the operational ready state, the braking system 6 finally switches to the awake mode.

In order to determine a current braking situation, the braking system 6 in the exemplary embodiment further comprises four wheel speed sensors 30, with each wheel 4 of the motor vehicle 2 being assigned a wheel speed sensor 30. In wake-up mode, the wheel speed sensors 30 generate sensor signals and as soon as the secondary control device 18 has executed its start-up procedure, it evaluates the sensor signals and determines based on them whether a non-critical or a critical braking situation exists. A braking situation is uncritical as long as none of the wheels 4 of the motor vehicle 2 is rotating and the braking situation becomes critical as soon as at least one of the wheels 4 begins to rotate.

The braking system 6 is also configured such that when a braking command is input while still in wake-up mode, the primary control device 16 controls the braking device 12 to generate a braking force depending on this input braking command if a non-critical braking situation exists, and that the secondary control device 18 controls the braking device 12 to generate a braking force depending on this input braking command if a critical braking situation exists.

This is particularly advantageous because, in the braking system 6 in the exemplary embodiment, the secondary start procedure is executed in a shorter time than the primary start procedure. As a result, even after operation of the braking system 6 in sleep mode, the secondary brake subsystem and in particular also the secondary part of the pressure control device 14 is always in an operational state at an earlier point in time than the primary brake subsystem and in particular also the primary part of the pressure control device 14.

### LIST OF REFERENCE NUMERALS

2 motor vehicle
4 wheel
6 braking system
8 wheel brake
10 brake cylinder
12 hydraulic system
14 pressure control device
16 primary control device
18 secondary control device
20 input device
22 brake pedal
24 brake pedal sensor
26 primary converter circuit
28 secondary converter circuit
29 wake-up circuit
30 wheel speed sensor

1. A braking system for a motor vehicle configured for a sleep mode, a wake-up mode and an awake mode, comprising:
an input device with an operating element via which braking commands can be input by a driver,
an electrically controllable braking device for generating braking forces,
a control device for controlling the braking device, wherein the control device has a primary control device and a secondary control device, and
a sensor device for generating sensor signals by which a braking situation can be determined,
wherein in the wake-up mode
the sensor signals of the sensor device are evaluated by the control device, wherein it is determined whether a critical or a non-critical braking situation exists, and
when a braking command is input, the primary control device controls the braking device to generate a braking force depending on the input braking command, if a non-critical braking situation exists, and the secondary control device controls the braking device to generate a braking force depending on the input braking command if a critical braking situation exists.

2. The braking system according to claim 1,
wherein the sensor device has a number of wheel speed sensors for generating the sensor signals and wherein in the wake-up mode the control device determines, based on the sensor signals of the wheel speed sensors, whether a critical or a non-critical braking situation exists.

3. The braking system according to claim 1,
wherein in the wake-up mode the primary control device executes a primary start-up procedure and the secondary control device executes a secondary start-up procedure, wherein the secondary start-up procedure is completed in a shorter time than the primary start-up procedure.

4. The braking system according to claim 1, further comprising:
a number of wheel brakes, wherein the electrically controllable braking device has an electrically controllable hydraulic system and wherein by the hydraulic system a hydraulic pressure can be predetermined in each wheel brake in order to generate a wheel braking force.

5. The braking system according to claim 4,
wherein the hydraulic system has an electrically controllable pressure control device with a primary part and with a secondary part, wherein the primary part is connected to the primary control device and the secondary part to the secondary control device, in terms of signal technology and wherein, on the one hand, wheel braking forces can be predetermined by the primary control device and by the primary part of the pressure control device, and, on the other hand, wheel braking forces can be predetermined by the secondary control device and by the secondary part of the pressure control device.

6. The braking system according to claim 4,
wherein a mechanical-hydraulic fallback level is omitted.

7. The braking system according to claim 4,
wherein in the awake mode, when a braking command is input, the primary control device controls the hydraulic system in such a way that a base pressure is hydraulically predetermined in each wheel brake as a function of the input braking command, and that the secondary control device controls the hydraulic system in such a way that, if necessary, the base pressure is individually varied in each wheel brake.

8. The braking system according to claim 7,
wherein the base pressure is varied individually in each wheel brake in order to thereby realize an ABS function and/or an ESP function.

9. The braking system according to claim 1,
wherein in the sleep mode the primary control device is decoupled from a power supply and that in the wake-up mode the secondary control device reconnects the primary control device to the power supply.

10. A motor vehicle comprising a braking system according to claim 1.

11. The braking system according to claim 2,
wherein in the wake-up mode the primary control device executes a primary start-up procedure and the secondary control device executes a secondary start-up procedure, wherein the secondary start-up procedure is completed in a shorter time than the primary start-up procedure.

12. The braking system according to claim 2, further comprising:
a number of wheel brakes, wherein the electrically controllable braking device has an electrically controllable hydraulic system and wherein by the hydraulic system a hydraulic pressure can be predetermined in each wheel brake in order to generate a wheel braking force.

13. The braking system according to claim 3, further comprising:
a number of wheel brakes, wherein the electrically controllable braking device has an electrically controllable hydraulic system and wherein by the hydraulic system a hydraulic pressure can be predetermined in each wheel brake in order to generate a wheel braking force.

14. The braking system according to claim 12,
wherein the hydraulic system has an electrically controllable pressure control device with a primary part and with a secondary part, wherein the primary part is connected to the primary control device and the secondary part to the secondary control device, in terms of signal technology and wherein, on the one hand, wheel braking forces can be predetermined by the primary control device and by the primary part of the pressure control device, and, on the other hand, wheel braking forces can be predetermined by the secondary control device and by the secondary part of the pressure control device.

15. The braking system according to claim 13,
wherein the hydraulic system has an electrically controllable pressure control device with a primary part and with a secondary part, wherein the primary part is connected to the primary control device and the secondary part to the secondary control device, in terms of signal technology and wherein, on the one hand, wheel braking forces can be predetermined by the primary control device and by the primary part of the pressure control device, and, on the other hand, wheel braking forces can be predetermined by the secondary control device and by the secondary part of the pressure control device.

16. The braking system according to claim 5,
wherein a mechanical-hydraulic fallback level is omitted.

17. The braking system according to claim 14,
wherein a mechanical-hydraulic fallback level is omitted.

18. The braking system according to claim 15,
wherein a mechanical-hydraulic fallback level is omitted.

19. The braking system according to claim 5,
wherein in the awake mode, when a braking command is input, the primary control device controls the hydraulic system in such a way that a base pressure is hydraulically predetermined in each wheel brake as a function of the input braking command, and that the secondary control device controls the hydraulic system in such a way that, if necessary, the base pressure is individually varied in each wheel brake.

20. The braking system according to claim 6,
wherein in the awake mode, when a braking command is input, the primary control device controls the hydraulic system in such a way that a base pressure is hydraulically predetermined in each wheel brake as a function of the input braking command, and that the secondary control device controls the hydraulic system in such a way that, if necessary, the base pressure is individually varied in each wheel brake.
